(19) United States
(12) Patent Application Publication
(10) Pub. No.: US 2004/0224117 A1
(43) Pub. Date: Nov. 11, 2004

(54) Pressure-sensitive adhesive members and processes for producing the same

(75) Inventor: Tsuneyuki Amano, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 10/861,364

(22) Filed: Jun. 7, 2004

Related U.S. Application Data
(62) Division of application No. 10/287,737, filed on Nov. 5, 2002.

(30) Foreign Application Priority Data
Nov. 8, 2001 (JP) P2001-343117
Nov. 8, 2001 (JP) P2001-343118

(51) Int. Cl. B32B 9/00

(52) U.S. Cl. 428/40.1

(57) ABSTRACT

A process includes (i) the steps of adhering a pressure-sensitive adhesive layer supported on a base material to a release layer containing a mixture of a polyethylene and an ethylene/α-olefin copolymer and aging the resultant structure at 40 to 75° C. for 6 hours or more or (ii) the steps of adhering a pressure-sensitive adhesive layer supported on a base material to a release layer containing a linear ethylene-based resin in which the content of components eluted at 30° C. or lower measured by the temperature rising elution fractionation method is 3 to 30 wt % and aging the resultant structure at 55 to 75° C. for 6 hours or more, to thereby regulate the pressure-sensitive adhesive layer so as to have a peel force of 0.5 to 5 N/50 mm when peeled from the release layer at an angle of 180° and a rate of 2 m/min together with the support base material.

### FIELD OF THE INVENTION

The present invention relates to pressure-sensitive adhesive members suitable for use in the field of precision electronics or the like in which the use of a silicone component such as, e.g., a silicone release agent is improper. The invention further relates to processes for producing these pressure-sensitive adhesive members.

### DESCRIPTION OF THE RELATED ART

Pressure-sensitive adhesive members such as pressure-sensitive adhesive tapes or labels are expensively used also in the field of precision electronics. Such pressure-sensitive adhesive members are generally in the form of a pressure-sensitive adhesive tape obtained by forming a pressure-sensitive adhesive layer on one side of a base material, forming a release layer on the other side thereof, and winding the resultant layered structure into a roll, or in the form of a label or the like comprising a base material, a pressure-sensitive adhesive layer formed thereon, and a release liner with which the pressure-sensitive adhesive layer is covered through a release layer. As the materials of these release layers are used non-silicone release materials because there is a possibility that use of silicone release agents might result in secondary fouling by silicones.

Known as the non-silicone release materials are polyolefin elastomers such as ethylene/α-olefin copolymers and mixtures of such a polyolefin elastomer and a polyethylene or another thermoplastic resin (see Japanese Patent Laid-Open Nos. 65281/1980, 80479/1980, and 155687/1994). These release materials are intended to mitigate the problems associated with the use of low-density polyethylene alone (Japanese Patent Publication No. 20205/1976) that considerable force is necessary for peeling (heavy peeling) and that the adhesive partly remains due to the poor peeling properties.

However, those non-silicone release materials are insufficient in producing the desired effects. Specifically, they have had the following problem. In a low-peeling-rate range of up to 0.5 m/min, the force required for peeling is sufficiently low and light peeling is attained. However, in a high-peeling-rate range of from 1 m/min, peeling is heavy and smooth peeling is difficult. This problem becomes severe when the pressure-sensitive adhesive member is allowed to stand for a prolonged time period in an atmosphere having a temperature of from room temperature to about 30° C. The problem of heavy peeling and difficulties in smooth peeling is causative of troubles, for example, that the pressure-sensitive adhesive layer cannot be peeled off at a practical peeling rate or is difficult to peel off, that smooth peeling should be discontinued and this causes the pressure-sensitive adhesive member to develop rumples or the like, and that the peeling makes a loud noise.

### SUMMARY OF THE INVENTION

A first aim of the invention is to provide a pressure-sensitive adhesive member which employs a non-silicone release material and which is lightly peelable in a peeling rate range of from a low to high rate and stably retains the lightly peelable properties even after long-term storage.

A second aim of the invention is to provide a pressure-sensitive adhesive member which employs a non-silicone release material and is lightly peelable in a peeling rate range of from a low to high rate.

The invention provides, according to the first aspect thereof, a process for producing a pressure-sensitive adhesive member which comprises adhering a pressure-sensitive adhesive layer supported on a base material to a release layer comprising a mixture of a polyethylene and an ethylene/α-olefin copolymer and then aging the resultant structure in an atmosphere having a temperature of from 40 to 75° C. for 6 hours or more to thereby regulate the pressure-sensitive adhesive layer so as to have a peel force of from 0.5 to 5 N/50 mm when peeled from the release layer at an angle of 180° and a rate of 2 m/min together with the support base material.

The invention further provides, according to the second aspect thereof, a process for producing a pressure-sensitive adhesive member which comprises adhering a pressure-sensitive adhesive layer supported on a base material to a release layer comprising a linear ethylene-based resin in which the content of components eluted at the temperatures not higher than 30° C. measured by the temperature rising elution fractionation method is from 3 to 30% by weight and then aging the resultant structure in an atmosphere having a temperature of from 55 to 75° C. for 6 hours or more to thereby regulate the pressure-sensitive adhesive layer so as to have a peel force of from 0.5 to 5 N/50 mm when peeled from the release layer at an angle of 180° and a rate of 2 m/mm together with the support base material.

According to the first aspect of the invention, a pressure-sensitive adhesive member can be obtained which employs a non-silicone release material and which is lightly peelable in a peeling rate range of from a low to high rate and stably retains the lightly peelable properties even after long-term storage. As stated above, release layers of the kind described above have a large dependence of peeling properties on peeling rate and it has been unavoidable that they come to necessitate a high peel force in a high-peeling-rate range. However, it has been unexpectedly found that by aging such a pressure-sensitive adhesive member in an atmosphere having the specific temperature shown above, not only light peeling in a high-peeling-rate range is attained, but also this property of being lightly peelable is maintained even after long-term standing for several months under ordinary storage conditions including a temperature of from ordinary temperature to about 30° C. and storage stability also is hence improved.

According to the second aspect of the invention, a pressure-sensitive adhesive member can be obtained which employs a non-silicone release material and is lightly peelable in a peeling rate range of from a low to high rate. As stated above, polyethylene-based release layers have a large dependence of peeling properties on peeling rate and it has been unavoidable that they come to necessitate a high peel force in a high-peeling-rate range. However, it has been unexpectedly found that by aging a pressure-sensitive adhesive member in an atmosphere having the specific temperature shown above, light peeling in a high-peeling-rate range is attained.

### BRIEF DESCRIPTION OF THE DRAWINGS

The foregoing and other aims and advantages of the invention will be apparent from the following detailed description and the accompanying drawings, in which:

FIG. 1 is a sectional view of one embodiment of the pressure-sensitive adhesive members according to the invention; and

FIG. 2 is a sectional view of another embodiment of the pressure-sensitive adhesive members according to the invention.

### DETAILED DESCRIPTION OF THE INVENTION

The process for producing a pressure-sensitive adhesive member according to the first aspect of the invention comprises adhering a pressure-sensitive adhesive layer supported on a base material to a release layer comprising a mixture of a polyethylene and an ethylene/α-olefin copolymer and then aging the resultant structure in an atmosphere having a temperature of from 40 to 75° C. for 6 hours or more to thereby regulate the pressure-sensitive adhesive layer so as to have a peel force of from 0.5 to 5 N/50 mm when peeled from the release layer at an angle of 180° and a rate of 2 m/min together with the support base material.

The process for producing a pressure-sensitive adhesive member according to the second aspect of the invention comprises adhering a pressure-sensitive adhesive layer supported on a base material to a release layer comprising a linear ethylene-based resin in which the content of components eluted at the temperatures not higher than 30° C. measured by the temperature rising elution fractionation method is from 3 to 30% by weight and then aging the resultant structure in an atmosphere having a temperature of from 55 to 75° C. for 6 hours or more to thereby regulate the pressure-sensitive adhesive layer so as to have a peel force of from 0.5 to 5 N/50 mm when peeled from the release layer at an angle of 180° and a rate of 2 m/min together with the support base material.

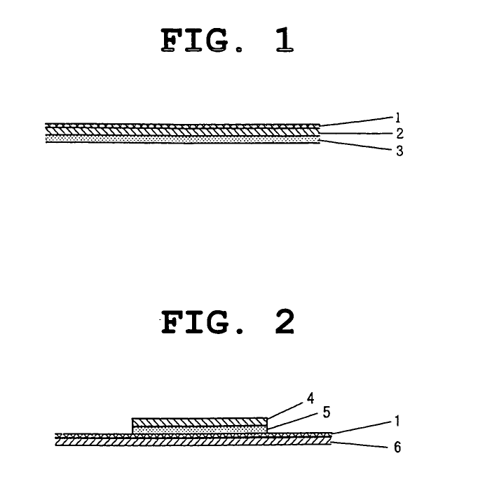

Embodiments of the pressure-sensitive adhesive members described above are shown in FIGS. 1 and 2. FIG. 1 shows an embodiment having a constitution which comprises a release layer and a pressure-sensitive adhesive layer united therewith through a base material. This constitution is typically utilized, for example, as pressure-sensitive adhesive tapes or the like. This embodiment comprises: a base material 2; a release layer 1 disposed on one side of the base material 2 and made of the linear ethylene-based resin or a mixture of a polyethylene and an ethylene/α-olefin copolymer; and a pressure-sensitive adhesive layer 3 formed on the other side of the base material 2. Usually, this pressure-sensitive adhesive member is utilized in the form of a roll obtained by winding the pressure-sensitive adhesive member so as to adhere the pressure-sensitive adhesive layer 3 to the release layer 2 on the back side thereof. Consequently, this pressure-sensitive adhesive member in a roll form can be subjected to the aging treatment.

On the other hand, FIG. 2 shows a pressure-sensitive adhesive member embodiment having a constitution which comprises: a base material 6; a release layer 1 disposed on a surface of the base material 6 and made of the linear ethylene-based resin or a mixture of a polyethylene and an ethylene/α-olefin copolymer; and a pressure-sensitive adhesive sheet which is composed of another base material 4 and a pressure-sensitive adhesive layer 5 formed thereon and is adherent to the release layer through the pressure-sensitive adhesive layer. This constitution, in which the release layer can be separated from the pressure-sensitive adhesive layer, is typically utilized, for example, as label base materials, labels, or the like, in which the pressure-sensitive adhesive sheet (4 and 5) is supported on the release liner (1 and 6). Consequently, this pressure-sensitive adhesive member in which the pressure-sensitive adhesive layer is adhered to the release layer can be subjected to the aging treatment.

The pressure-sensitive adhesive members are not limited to the embodiments shown above, and may be one which has a pressure-sensitive adhesive layer not only on one side of the base material but on the other side. In this case, a separator or release liner which has on each side thereof a release layer made of the linear ethylene-based resin or a mixture of a polyethylene and an ethylene/α-olefin copolymer may be used to constitute the pressure-sensitive adhesive member in the form of, e.g., a roll capable of being easily unwound. Consequently, the pressure-sensitive adhesive members according to the invention can be formed so as to have the constitutions of conventional pressure-sensitive adhesive members represented by pressure-sensitive adhesive tapes, double-faced pressure-sensitive adhesive tapes, surface-protective sheets, label sheets, and the like.

In the process according to the first aspect of the invention, a release layer is formed from a mixture of a polyethylene and an ethylene/α-olefin copolymer for the purpose of eliminating the use of a silicone. The polyethylene is not particularly limited and may be a suitable one such as high-density, medium-density, or low-density polyethylene. Especially preferred of these is a polyethylene having an average molecular weight of 10,000 or higher, preferably from 12,000 to 1,500,000, more preferably from 15,000 to 1,000,000, and a density of from 0.91 to 0.97 g/cm³ from the standpoint of obtaining the desired release performance.

On the other hand, the ethylene/α-olefin copolymer also is not particularly limited and may be a suitable one such as, e.g., an ethylene/propylene copolymer or an ethylene/1-butene random copolymer. Especially preferred of these from the standpoint of obtaining the desired release performance is an ethylene/α-olefin copolymer having a density of from 0.80 to 0.90 g/cm³, a brittle temperature as measured through a test in accordance with ASTM D-746 of −70° C. or lower, and a melting point as measured by differential thermal analysis of 80° C. or lower.

In forming a release layer, the polyethylene and the ethylene/α-olefin copolymer are used in such a proportion that the ratio of the weight of the polyethylene to that of the ethylene/α-olefin copolymer is preferably from 95/5 to 20/80, more preferably from 90/10 to 50/50. When the proportion by weight of the ethylene/α-olefin copolymer is lower than 5%, there are cases where sufficient release performance is not obtained. When the proportion thereof exceeds 80%, there are cases where the release layer has insufficient film strength or poor heat resistance.

In the process according to the second aspect of the invention, a release layer is formed from a linear ethylene-based resin in which the content of components eluted at the temperatures not higher than 30° C. measured by the temperature rising elution fractionation (TREF) method is from 3 to 30% by weight, preferably up to 20% by weight, more preferably from 4 to 15% by weight, based on the whole resin material for the purpose of eliminating the use of a silicone. Linear ethylene-based resins in which the content of those components eluted is lower than 3% by weight have poor release performance and are unable to accomplish the purpose. On the other hand, linear ethylene-based resins in which the content thereof exceeds 30% by weight not only are too flexible to retain their shape but have poor heat resistance.

The temperature rising elution fractionation method can be conducted, for example, in the following manner. A linear ethylene-based resin is dissolved in o-dichlorobenzene having a temperature at which the resin completely dissolves therein, e.g., 140° C. This solution is cooled to −10° C. at a constant rate, e.g., 1° C./min, to thereby form a thin polymer layer in the TREF column packed with glass beads as an inert support. In this polymer layer formation, highly crystalline polymer components, which are apt to crystallize, deposit first and lowly crystalline or noncrystalline polymer components, which are less apt to crystallize, deposit thereafter.

Subsequently, the column is held at −10° C. for 60 minutes, and the temperature thereof is then elevated by stages while passing o-dichlorobenzene as a mobile phase through the column at a flow rate of 1 ml/min. As a result, lowly crystalline or noncrystalline components are eluted first and highly crystalline components are eluted thereafter; this order is the reverse of that in the deposition. The amounts of the components which were thus eluted successively at respective temperatures are plotted against elution temperature to obtain an elution curve. From this elution curve, the compositional distribution of this resin material is analyzed. This operation can be realized with a known apparatus for the temperature rising elution fractionation method, such as, e.g., a cross fractionation chromatograph (CFC Type T-150A, manufactured by Mitsubishi Chemical Corp. (former name: Mitsubishi Petrochemical Company, Ltd.)).

The linear ethylene-based resin is one having an ethylene component content of generally 50% by weight or higher, preferably 60% by weight or higher, more preferably 70% by weight or higher. Examples thereof include linear ethylene resins, mixtures mainly containing a linear ethylene resin and containing other resin component(s) or additive(s), and copolymers of an α-olefin having 3 to 12 carbon atoms and ethylene. These may be used alone or in combination of two or more thereof. A linear ethylene-based resin satisfying the requirement concerning the amount of components eluted can be obtained, for example, by suitably selecting conditions for copolymerization, purification, and/or fractionation each conducted by a known method. A commercial product of the resin is also available.

In the process according to the second aspect of the invention, the α-olefin to be used for producing a copolymer with ethylene is not particularly limited. Examples thereof include α-olefins having 3 to 12 carbon atoms, such as propylene, 1-butene, 1-hexene, 4-methyl-1-pentene, and 1-octene. The copolymer may be one obtained from monomers including one or more α-olefins having 3 to 12 carbon atoms. Especially preferred examples of the copolymer include ethylene/1-butene copolymers, ethylene/4-methyl-1-pentene copolymers, ethylene/1-hexene copolymers, and ethylene/1-octene copolymers.

By using the linear ethylene-based resin, a material for release layer formation can be prepared through a smaller number of steps than in the conventional techniques in which a resin mixture containing low-density polyethylene and an ethylene/propylene copolymer, ethylene/1-butene random copolymer, or the like is used. Use of the linear ethylene-based resin further has an advantage that a release layer having excellent release properties can be efficiently formed more easily.

The release layer has so high release performance that it is suitable for use in pressure-sensitive adhesive tapes, labels, and the like. Even when used in combination with a pressure-sensitive adhesive layer having high adhesive strength, the release layer shows excellent release performance and is less apt to suffer adhesion of a pressure-sensitive adhesive residue thereto upon peeling and to arouse peeling troubles such as stick-slip. Consequently, the release layer further has an advantage that the pressure-sensitive adhesive layer which has been exposed through peeling can retain moderate surface roughness.

Examples of the resin component(s) with which the linear ethylene resin may be mixed include other polyethylenes, homopolymers of the aforementioned α-olefins, and copolymers of two or more α-olefins. One or more of these can be incorporated. The amount of such resin components or additives to be incorporated may be in such a range that the release properties, film-forming properties, solvent resistance, and heat resistance of the linear ethylene-based resin are not impaired by the incorporation.

The release layer can be obtained as a film having a thickness of from 20 to 500 μm so as to serve also as a base material. In general, however, the release layer is supported on a base material, as in the embodiments shown in the figures, in order to improve rigidity and strength or for another purpose. In the case of the pressure-sensitive adhesive members described above, such as pressure-sensitive adhesive tapes of the united type in which the release layer has been united with the pressure-sensitive adhesive layer and release liners or separators of the separable type in which the release layer can be separated from the pressure-sensitive adhesive layer, it is preferred that the pressure-sensitive adhesive members have a constitution in which the release layer is supported on a base material.

For forming a release layer supported on a base material, an appropriate technique can be used, such as, e.g., a method in which a solution or melt of a material for release layer formation is applied to a base material to form a coating film, a method in which a film of the material is fusion-bonded to a base material, and a method in which the material is subjected to coextrusion molding together with a plastic for forming a base material to thereby form a laminate. In thus forming a release layer, the thickness thereof is not particularly limited and can be suitably determined. In general, the thickness of the release layer is from 1 to 100 μm, preferably from 5 to 50 μm, more preferably from 10 to 40 μm, from the standpoints of stable formation of the release layer, thickness reduction thereof, etc.

The base material on which the release layer or pressure-sensitive adhesive layer is supported can be an appropriate thin sheet material and may be any of the base materials employed in pressure-sensitive adhesive members heretofore in use. Examples thereof include films or sheets made of various plastics, papers, fabrics, nonwoven fabrics, metal foils, nets, foams, and laminates of these. The base material may be one which has a layer of an electrical conductor or magnetic material and/or contains electroconductive particles or magnetic particles so as to be capable of high-frequency induction heating.

In applications where participation of a silicone is improper, as in the field of precision electronics, the presence of paper dust particles also is improper. Because of this, preferred base materials for use in such applications are films made of various plastics such as, e.g., polyesters, polyamides, polypropylene, high-density polyethylene, and polyimides. Although the base material thickness can be suitably determined, it is generally 500 μm or smaller, preferably from 5 to 300 μm, more preferably from 10 to 250 μm.

In the case of a pressure-sensitive adhesive member of the type capable of being separated into, e.g., a pressure-sensitive adhesive sheet and a release liner, like the embodiment shown in FIG. 2, the base material in the pressure-sensitive adhesive sheet and the base material in the release liner may be the same or different in kind. When this pressure-sensitive adhesive sheet is a label base material, it preferably is a base material on which ink information can be fixed by the thermal transfer method.

As the base material on which ink information can be fixed, use can be made of an appropriate base material employed in usual labels, such as, e.g., any of the plastic films shown above or a paper. Printing by the thermal transfer method has an advantage that necessary ink information can be printed in situ upon occasion while changing the contents to thereby produce labels according to circumstances. That side of the base material on which a release layer or pressure-sensitive adhesive layer is to be formed can be subjected to an appropriate surface treatment for improving adhesion, etc., according to need. Examples of the treatment include anchor coating, corona discharge treatment, chromic acid treatment, exposure to ozone, exposure to a flame, exposure to a high-voltage electric shock, and treatment with an ionizing radiation.

In the case where a base material on which a release layer is to be supported is formed from polypropylene, it is preferred to use a method in which a material for release layer formation and the polypropylene are coextrusion-molded to obtain a laminate film, because this method is advantageous in adhesion between the release layer and the base material, production efficiency, etc. The thickness of the polypropylene film layer thus formed is preferably from 30 to 120 μm when the thickness of the release layer is from 5 to 50 μm.

For forming the pressure-sensitive adhesive layer in each of the pressure-sensitive adhesive members, use can be made of any of various pressure-sensitive adhesives comprising as the base polymer one or more appropriate polymers selected, for example, from rubbers, acrylic polymers, vinyl alkyl ether polymers, polyesters, polyamides, and urethane polymers. It is hence possible to use a pressure-sensitive adhesive of the ultraviolet-curable type, hot-melt type, high-temperature pressure-sensitive type, or another type. Such pressure-sensitive adhesives may contain appropriate additives such as, e.g., a crosslinking agent, tackifier, plasticizer, filler, and antioxidant according to need.

From the standpoints of nonuse of a silicone component, release performance, etc., it is especially preferred to use an acrylic pressure-sensitive adhesive comprising as the base polymer an acrylic polymer obtained by polymerizing one or more alkyl (meth)acrylates which are acrylic or methacrylic esters having an alkyl group having up to 20 carbon atoms, optionally together with one or more other appropriate monomers for the purpose of regulating bulk properties such as cohesive force, heat resistance, suitability for crosslinking, etc.

For forming the pressure-sensitive adhesive layer, an appropriate technique can be used, such as, e.g., a method in which a pressure-sensitive adhesive is applied to a base material by an appropriate technique such as doctor blade coating or gravure printing or a method in which a pressure-sensitive adhesive layer thus formed on a separator or the like is transferred to a base material. Although the thickness of the pressure-sensitive adhesive layer can be suitably determined according to the intended use, etc., it is generally 500 μm or smaller, preferably from 1 to 300 μm, more preferably from 5 to 100 μm. The pressure-sensitive adhesive layer may be one which has undergone an appropriate treatment, e.g., a crosslinking treatment with electron beam irradiation, for the purpose of regulating bulk properties or for another purpose.

The pressure-sensitive adhesive member according to the first aspect of the invention has been regulated so that when the pressure-sensitive adhesive layer adhered to the release layer is peeled from the release layer at an angle of 180° and a rate of 2 m/min together with the support base material, the force required for the peeling (peel force) is from 0.5 to 5 N/50 mm. This peel force can be attained, for example, by aging the pressure-sensitive adhesive layer adhered to the release layer in an atmosphere having a temperature of from 40 to 75° C. for 6 hours or more.

In case where the aging temperature is lower than 40° C., the property of being lightly peeled in a high-peeling-rate range and the retention of such peelable properties after long-term storage cannot be attained. In case where the aging temperature exceeds 75° C., peeling becomes heavier rather than light. The effect of this aging begins to be produced at about 1 hour after initiation of the aging, and a satisfactory state is reached in 6 hours. From the standpoint of stably attaining the effect, the aging period is preferably 10 hours or more, more preferably 15 hours or more, most preferably 20 hours or more. Although the upper limit of the aging period is not particularly limited, the period is preferably up to 120 hours from the standpoints of production efficiency, etc.

Consequently, the aging treatment described above considerably differs in temperature range from the conventional treatment which is conducted according to need for the purpose of accelerating the crosslinking of the pressure-sensitive adhesive layer or stabilizing the adhesion of the pressure-sensitive adhesive layer to the release layer. The aging treatment in the invention and such conventional treatment are distinctive from each other. Namely, the conventional treatment makes no contribution to the property of being lightly peeled in a high-peeling-rate range or the long-term storage stability, the attainment of which is an aim of the invention.

The pressure-sensitive adhesive member according to the second aspect of the invention has been regulated so that when the pressure-sensitive adhesive layer adhered to the release layer is peeled from the release layer at an angle of 180° and a rate of 2 m/min together with the support base material, the force required for the peeling (peel force) is from 0.5 to 5 N/50 mm. This peel force can be attained, for example, by aging the pressure-sensitive adhesive layer adhered to the release layer in an atmosphere having a temperature of from 55 to 75° C. for 6 hours or more.

In case where the aging temperature is lower than 55° C., the property of being lightly peeled in a high-peeling-rate range cannot be attained. In case where the aging temperature exceeds 75° C., peeling becomes heavier rather than light. The effect of this aging begins to be produced at about 1 hour after initiation of the aging, and a satisfactory state is reached in 6 hours. From the standpoint of stably attaining the effect, the aging period is preferably 10 hours or more, more preferably 15 hours or more, most preferably 20 hours or more. Although the upper limit of the aging period is not particularly limited, the period is preferably up to 120 hours from the standpoints of production efficiency, etc.

Consequently, the aging treatment described above considerably differs in temperature range from the conventional treatment which is conducted according to need for the purpose of accelerating the crosslinking of the pressure-sensitive adhesive layer or stabilizing the adhesion of the pressure-sensitive adhesive layer to the release layer. The aging treatment in the invention and such conventional treatment are distinctive from each other. Namely, the conventional treatment makes no contribution to the property of being lightly peeled in a high-peeling-rate range, the attainment of which is an aim of the invention.

The pressure-sensitive adhesive members of the invention can be used for various purposes as, e.g., labels, stickers, seals, emblems, vouchers, notice boards, packaging tapes, surface-protective materials, pressure-sensitive adhesive tapes, or the like in various fields such as commercial applications, industrial applications, agricultural applications, medical applications, optical applications, office applications, and domestic applications. In particular, from the standpoint of attaining the nonuse of a silicone, the pressure-sensitive adhesive members can be advantageously used in fields where the participation of a silicone component is undesirable, such as the field of precision electronics.

The invention will be explained below in more detail by reference to the following Examples and Comparative Examples, but the invention should not be construed as being limited to these Examples.

### EXAMPLE 1

A mixture of 80 parts (parts by weight; the same applies hereinafter) of low-density polyethylene having a density of 0.920 g/cm³ (AC41SA, manufactured by Japan Polyolefins Co., Ltd.) and 20 parts of an ethylene/α-olefin copolymer having a density of 0.88 g/cm³ (Tafmer P0180, manufactured by Mitsui Chemicals, Inc.) was subjected to coextrusion molding at 230° C. together with polypropylene (FY-4, manufactured by Japan Polychem Corp.) to obtain a release liner consisting of a laminate composed of a release layer having a thickness of 30 μm and a polypropylene layer having a thickness of 80 μm.

On the other hand, an acrylic pressure-sensitive adhesive layer having a thickness of 30 μm was formed on the corona-treated side of a 50 μm-thick white polyester film (W400C, manufactured by Mitsubishi Chemical Corp.). This pressure-sensitive adhesive layer was adhered to the release layer of the release liner. The resultant structure was aged at 65° C. for 48 hours to obtain a pressure-sensitive adhesive member for label formation.

### EXAMPLE 2

A mixture of 70 parts of low-density polyethylene having a density of 0.921 g/cm³ (Mirason NEO23H, manufactured by Mitsui Chemicals, Inc.) and 30 parts of the ethylene/α-olefin copolymer (Tafmer P0180) was applied by extrusion coating at 250° C. to a 50 μm-thick polyester film through an undercoat layer to obtain a release liner in which a release layer having a thickness of 20 μm had been laminated. A pressure-sensitive adhesive member was obtained in the same manner as in Example 1, except that the release liner thus obtained was used.

### EXAMPLE 3

A pressure-sensitive adhesive member was obtained in the same manner as in Example 1, except that the aging conditions were changed to 40° C. and 48 hours.

### COMPARATIVE EXAMPLE 1

A pressure-sensitive adhesive member was obtained in the same manner as in Example 1, except that the aging conditions were changed to 25° C. and 7 days.

### COMPARATIVE EXAMPLE 2

A pressure-sensitive adhesive member was obtained in the same manner as in Example 1, except that a release layer was formed from the polyethylene alone.

### COMPARATIVE EXAMPLE 3

A pressure-sensitive adhesive member was obtained in the same manner as in Example 2, except that a release layer was formed from the polyethylene alone.

### Evaluation Test

Six samples having a width of 50 mm were cut out of each of the pressure-sensitive adhesive members obtained in the Examples and Comparative Examples. Each sample was adhered and fixed on its release liner side to a rigid plate, and subjected to a 180° peel test to measure the peel force. In this test, the pressure-sensitive adhesive sheet side was pulled with a universal tensile tester (RTM-100, manufactured by ORIENTEC Co., Ltd.) in an atmosphere having a temperature of 23° C. and a humidity of 60% RH at a crosshead speed of 0.3 m/min (low-speed peeling) or 2.0 m/min (high-speed peeling). Three test pieces were thus tested at each crosshead speed, and the found values were averaged. This test was conducted with respect to samples which had been stored at 30° C. for 6 months and ones which had not undergone the storage.

The results of the evaluation are shown in Table 1 (A: before storage, B: after storage).

TABLE 1

| Peel force | Example | | | | | | Comparative Example | | | | | |
|---|---|---|---|---|---|---|---|---|---|---|---|---|
| (N/50 | 1 | | 2 | | 3 | | 1 | | 2 | | 3 | |
| mm) | A | B | A | B | A | B | A | B | A | B | A | B |
| Low-speed | 0.3 | 0.3 | 0.4 | 0.4 | 0.3 | 0.3 | 0.7 | 0.7 | 0.3 | 0.4 | 1.1 | 1.2 |
| Peeling | | | | | | | | | | | | |
| High-speed | 1.4 | 1.6 | 2.8 | 3.1 | 1.5 | 1.8 | 11.8 | 10.6 | 2.1 | 8.6 | 12.1 | 12.5 |
| Peeling | | | | | | | | | | | | |

Table 1 shows the following. In the low-speed peeling, the pressure-sensitive adhesive members obtained in the Comparative Examples showed lightly peelable properties like the pressure-sensitive adhesive members obtained in the Examples. In the high-speed peeling, however, the pressure-sensitive adhesive members of the Examples retained the satisfactory lightly peelable properties regardless of whether or not they had undergone the long-term storage, whereas in each of the pressure-sensitive adhesive members of the Comparative Examples, at least either of the samples which had not undergone the long-term storage and the samples which had undergone the storage showed heavy peeling.

### EXAMPLE 4

An ethylene/1-hexene copolymer (J-REX LLAC41SA, manufactured by Japan Polyolefins Co., Ltd.) as a linear ethylene-based resin and polypropylene (FY-4, manufactured by Japan Polychem Corp.) were coextrusion-molded at 230° C. to obtain a release liner consisting of a laminate composed of a release layer having a thickness of 30 μm and a polypropylene layer having a thickness of 80 μm. The linear ethylene-based resin was analyzed with a cross fractionation chromatograph (CFC Type T-150A) by the temperature rising elution fractionation method (the same applies hereinafter). As a result, the amount of components eluted at the temperatures not higher than 30° C. was 7.8% by weight based on the whole resin.

On the other hand, an acrylic pressure-sensitive adhesive layer having a thickness of 30 μm was formed on the corona-treated side of a 50 μm-thick white polyester film (W400C, manufactured by Mitsubishi Chemical Corp.). This pressure-sensitive adhesive layer was adhered to the release layer of the release liner. The resultant structure was aged at 55° C. for 48 hours to obtain a pressure-sensitive adhesive member for label formation.

### EXAMPLE 5

An ethylene/1-octene copolymer having a content of components eluted at the temperatures not higher than 30° C. of 4.8% by weight (Moretec 0218CN, manufactured by Idemitsu Petrochemical Co., Ltd.) as a linear ethylene-based resin was applied by extrusion coating at 250° C. to a 50 μm-thick polyester film through an undercoat layer to obtain a release liner in which a release layer having a thickness of 20 μm had been laminated. A pressure-sensitive adhesive member was obtained in the same manner as in Example 4, except that the release liner thus obtained was used and aging was conducted at 70° C. for 48 hours.

### EXAMPLE 6

A pressure-sensitive adhesive member was obtained in the same manner as in Example 5, except that a linear ethylene-based resin which consisted of an ethylene/1-octene copolymer containing 20% by weight of low-density polyethylene and had a content of components eluted at the temperatures not higher than 30° C. of 5.4% by weight (Moretec 1018D, manufactured by Idemitsu Petrochemical Co., Ltd.) was used, and that aging was conducted at 65° C. for 48 hours.

### COMPARATIVE EXAMPLE 4

A pressure-sensitive adhesive member was obtained in the same manner as in Example 4, except that the aging conditions were changed to 40° C. and 48 hours.

### COMPARATIVE EXAMPLE 5

A pressure-sensitive adhesive member was obtained in the same manner as in Example 4, except that an ethylene/1-hexene copolymer having a content of components eluted at the temperatures not higher than 30° C. of 1.0% by weight (Evolue SP1540, manufactured by Mitsui Chemicals, Inc.) was used as a linear ethylene-based resin.

### Evaluation Test

Six samples having a width of 50 mm were cut out of each of the pressure-sensitive adhesive members obtained in the Examples and Comparative Examples. Each sample was adhered and fixed on its release liner side to a rigid plate, and subjected to a 180° peel test to measure the peel force. In this test, the pressure-sensitive adhesive sheet side was pulled with a universal tensile tester (RTM-100, manufactured by ORIENTEC Co., Ltd.) in an atmosphere having a temperature of 23° C. and a humidity of 60% RH at a crosshead speed of 0.3 m/min (low-speed peeling) or 2.0 m/min (high-speed peeling). Three test pieces were thus tested at each crosshead speed, and the found values were averaged.

The results of the evaluation are shown in Table 2.

TABLE 2

| Peel force | Example | | | Comparative Example | |
|---|---|---|---|---|---|
| (N/50 mm) | 4 | 5 | 6 | 4 | 5 |
| Low-speed | 0.3 | 0.4 | 0.3 | 0.4 | 0.4 |
| peeling | | | | | |
| High-speed | 1.5 | 3.2 | 2.1 | 11.8 | 8.6 |
| peeling | | | | | |

Table 2 shows the following. In the low-speed peeling, the pressure-sensitive adhesive members obtained in the Comparative Examples showed lightly peelable properties like the pressure-sensitive adhesive members obtained in the Examples. In the high-speed peeling, however, the pressure-sensitive adhesive members of the Examples retained the satisfactory lightly peelable properties, whereas the pressure-sensitive adhesive members of the Comparative Examples showed heavy peeling.

While the invention has been described in detail and with reference to specific embodiments thereof, it will be apparent to one skilled in the art that various changes and modifications can be made therein without departing from the spirit and scope thereof.

1-13 (canceled)

14. A process for producing a pressure-sensitive adhesive member which comprises adhering a pressure-sensitive adhesive layer supported on a base material to a release layer comprising a linear ethylene-based resin in which the content of components eluted at the temperatures not higher than 30° C. measured by the temperature rising elution fractionation method is from 3 to 30% by weight and then aging the resultant structure in an atmosphere having a temperature of from 55 to 75° C. for 6 hours or more to thereby regulate the pressure-sensitive adhesive layer so as to have a peel force of from 0.5 to 5 N/50 mm when peeled from the release layer at an angle of 180° and a rate of 2 m/min together with the support base material.

15. A pressure-sensitive adhesive member which comprises a base material, a release layer disposed on one side of the base material and comprising a linear ethylene-based resin in which the content of components eluted at the temperatures not higher than 30° C. measured by the temperature rising elution fractionation method is from 3 to 30% by weight based on the whole resin material, and a pressure-sensitive adhesive layer disposed on the other side of the base material, wherein the pressure-sensitive adhesive layer has a peel force of from 0.5 to 5 N/50 mm when adhered to the release layer and peeled therefrom at an angle of 180° and a rate of 2 m/min.

16. A pressure-sensitive adhesive member which comprises a base material, a release layer disposed on a surface of the base material and comprising a linear ethylene-based resin in which the content of components eluted at the temperatures not higher than 30° C. measured by the temperature rising elution fractionation method is from 3 to 30% by weight based on the whole resin material, and a pressure-sensitive adhesive sheet which comprises another base material and a pressure-sensitive adhesive layer formed thereon and is adherent to the release layer through the pressure-sensitive adhesive layer, wherein the pressure-sensitive adhesive sheet has a peel force of from 0.5 to 5 N/50 mm when peeled from the release layer at an angle of 180° and a rate of 2 m/min.

17. The pressure-sensitive adhesive member as claimed in claim 16, wherein the pressure-sensitive adhesive sheet is a label base material or a label.

18. The pressure-sensitive adhesive member as claimed in claim 17, wherein the label base material comprises a base material on which ink information can be fixed by the thermal transfer method.

19. The pressure-sensitive adhesive member as claimed in claim 15, wherein the linear ethylene-based resin as a component of the release layer is a copolymer of ethylene and one or more α-olefins having 3 to 12 carbon atoms.

20. The pressure-sensitive adhesive member as claimed in claim 16, wherein the linear ethylene-based resin as a component of the release layer is a copolymer of ethylene and one or more α-olefins having 3 to 12 carbon atoms.

21. The pressure-sensitive adhesive member as claimed in claim 15, wherein the pressure-sensitive adhesive layer comprises an acrylic pressure-sensitive adhesive.

22. The pressure-sensitive adhesive member as claimed in claim 16, wherein the pressure-sensitive adhesive layer comprises an acrylic pressure-sensitive adhesive.

23. The pressure-sensitive adhesive member as claimed in claim 15, wherein the release layer has a thickness of from 5 to 50 μm, the base material on which the release layer is supported comprises a polypropylene film having a thickness of from 30 to 120 μm, and the release layer and the base material constitute a laminate formed by coextrusion molding.

24. The pressure-sensitive adhesive member as claimed in claim 16, wherein the release layer has a thickness of from 5 to 50 μm, the base material on which the release layer is supported comprises a polypropylene film having a thickness of from 30 to 120 μm, and the release layer and the base material constitute a laminate formed by coextrusion molding.
